(19) United States
(12) Patent Application Publication
(10) Pub. No.: US 2017/0221083 A1
(43) Pub. Date: Aug. 3, 2017

(54) DYNAMIC GENERATION OF SURVEY QUESTIONS FROM CONTEXT BASED RULES

(71) Applicant: International Business Machines Corporation, Armonk, NY (US)

(72) Inventors: John K. Gerken, III, Apex, NC (US); Jeremy A. Greenberger, Raleigh, NC (US)

(21) Appl. No.: 15/409,575

(22) Filed: Jan. 19, 2017

Related U.S. Application Data
(63) Continuation of application No. 15/012,916, filed on Feb. 2, 2016.

(51) Int. Cl. G06Q 30/02; G06F 17/30; H04W 4/04

(52) U.S. Cl. CPC G06Q 30/0203; H04W 4/043; G06F 17/30528; G06F 17/30507; G06F 17/30241

(57) ABSTRACT

A method includes receiving data identifying one or more movement characteristics of a mobile device at a venue. The method further includes creating a context from the data. The method further includes dynamically generating one or more survey questions. Generating the one or more survey questions further includes applying the context to one or more context based rules. The method further includes transmitting the one or more survey questions to a mobile device. The method further includes receiving, from the mobile device, one or more responses to the one or more survey questions. A corresponding computer system and computer program product are also disclosed.

### BACKGROUND

The present disclosure relates generally to generating survey questions and in particular to dynamically generating survey questions from context based rules.

The Internet of Things (“IoT”) is a network of physical objects or “things” embedded with electronics, software, sensors, and network connectivity, which enable these objects to collect and exchange data. The IoT allows objects to be sensed and controlled remotely across existing network infrastructure, creating opportunities for more direct integration between the physical world and computer-based systems. This direct integration between the physical world and computer-based systems has resulted in the development of various new avenues for businesses to solicit customer feedback (e.g., mobile surveys), improve customer satisfaction, and generate higher revenue.

### SUMMARY

A method includes receiving data identifying one or more movement characteristics of a mobile device at a venue. The method further includes creating a context from the data. The method further includes dynamically generating one or more survey questions. Generating the one or more survey questions further includes applying the context to one or more context based rules. The method further includes transmitting the one or more survey questions to a mobile device. The method further includes receiving, from the mobile device, one or more responses to the one or more survey questions. A corresponding computer system and computer program product are also disclosed.

### BRIEF DESCRIPTION OF THE DRAWINGS

FIG. 1 is a block diagram of a computer system environment suitable for operation in accordance with at least one embodiment of the invention.

FIG. 2 is a network diagram of an operational environment for the survey generator program in accordance with at least one embodiment of the invention.

FIG. 3 is a flow chart diagram depicting operational steps for a survey generator program in accordance with at least one embodiment of the invention.

FIG. 4 is an exemplary diagram for a portion of a working example of the survey generator program in accordance with at least one embodiment of the invention.

FIG. 5 is a block diagram depicting components of a computer suitable for executing the survey generator program in accordance with at least one embodiment of the invention.

### DETAILED DESCRIPTION

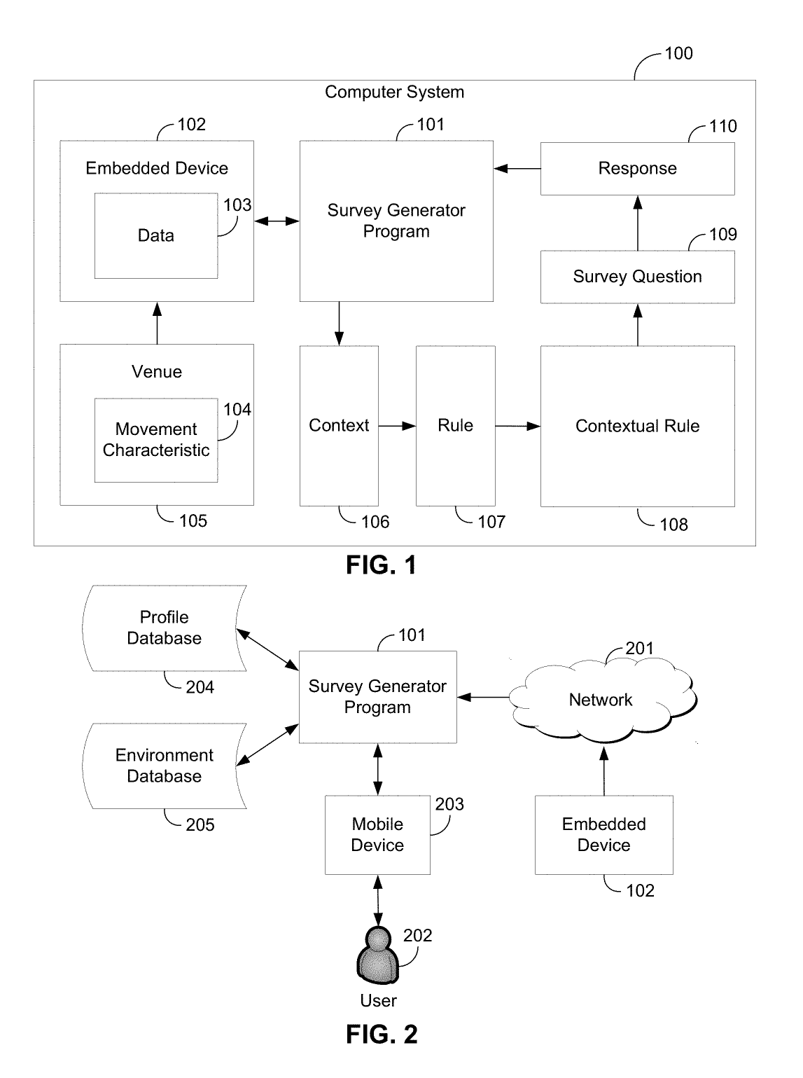

Referring now to various embodiments of the invention in more detail, FIG. 1 is a block diagram of a computer system environment suitable for operation in accordance with at least one embodiment of the invention. Within a computer system 100, a survey generator program 101 may receive data 102 identifying one or more movement characteristics of a mobile device 103 at a venue. More specifically, the survey generator program 101 may receive the data 102 from one or more devices. In one embodiment of the invention, the survey generator program 101 may receive data 102 identifying the one or more movement characteristics of the mobile device 103 directly from the mobile device 103 itself. In another embodiment of the invention, the survey generator program 101 may receive data 102 identifying the one or more movement characteristics of the mobile device 103 from a network of embedded devices 104 located in a venue. The network of embedded devices 104 may be a network of physical objects or “things” embedded with electronics and software (e.g., sensors, physical items having radio frequency identification (“RFID”) tags, etc.). A venue may be understood generally as any physical location in which an individual may traverse and more specifically, as a physically defined location (e.g., merchant, store, hospital, airport, etc.). Furthermore, the venue may include one or more designated areas or zones (e.g., men's clothing, women's clothing, checkout line, waiting room, foyer, cafeteria, parking lot, etc.). Each designated area or zone may further be divided (e.g., partitions, walls, and isles, etc.).

The survey generator program 101 may further create a context 105 from the data 102. Context 105 may be understood as any information that can characterize the situation of an entity. An entity may be a person, place or object that is considered relevant to the interaction between a user and an application, including the user and applications themselves, and by extension, the environment in which the user and applications are embedded.

The survey generator program 101 may further dynamically generate one or more survey questions 107. Generating the one or more survey questions 107 may further include applying the context 105 to one or more context based rules 106. Dynamic generation may be understood as the generation of survey questions based on data that is not static. More specifically, the survey questions 107 may be customized based on received data 102, such that each time a survey question 107 is generated, the question may change as the data 102 from which the question is based changes. A context based rule 106 may be understood as a categorical framework for which the survey generator program 101 may dynamically generate a survey question 107 when a particular context 105 is applied to the context based rule 106. More specifically, the one or more survey questions are venue-specific survey questions customized for the user of the mobile device.

The survey generator program 101 may further transmit the one or more survey questions 107 to the mobile device 103 (e.g., a mobile device, such as a smartphone, tablet, smartwatch, etc.). The survey generator program 101 may further receive, from the mobile device 103, one or more responses 108 to the one or more survey questions.

FIG. 2 is a network diagram of an operational environment for the survey generator program 101 in accordance with at least one embodiment of the invention. In FIG. 2, the survey generator program 101 may exist in a remote environment on defined server hardware 201. In another embodiment (not shown), the survey generator program 101 may exist in a cloud-based, virtual, or distributed environment. In either embodiment, the survey generator program 101 may be in communication with one or more devices.

For example, the survey generator program 101 may be in direct communication with a mobile device 103. Here, the mobile device 103 may detect its own movement characteristics (e.g., via a global positioning system (“GPS”)) and transmit the data 102 to the survey generator program 101. In another example, the survey generator program 101 may be in communication with a network 202 of embedded devices 104. More specifically, the network 202 of embedded devices 104 may be “nodes” in a wireless sensor network (“WSN”). Here, the WSN may include spatially distributed autonomous sensors that detect the one or more movement characteristics of the mobile device 103 at a venue. Typically, each sensor network node has several parts, including a radio transceiver with an internal antenna or connection to an external antenna, a microcontroller, an electronic circuit for interfacing with the sensors, and an energy source (e.g., a battery or embedded form of energy harvesting). The network of embedded devices 104 may identify the one or more movement characteristics of the mobile device 103 by any generally known micro-location enabling technologies. Examples of micro-location enabling technologies include, but are not limited to Bluetooth Low Energy (“BLE”) based beacons, Ultra-Wideband (“UWB”) based radio technology, Wireless Positioning Systems (“WPS”), Magnetic Field Mapping (“MFP”), Radio Frequency Identification (“RFID”), and Near-Field Communication (“NFC”).

In many applications, a WSN may communicate with a Local Area Network (“LAN”) or Wide Area Network (“WAN”) through a gateway, which acts as a bridge between the WSN 201 and another network. Here, the survey generator program 101 may receive data 102 from the network 202 of embedded devices 104 by any generally known messaging protocols, including, but not limited to message queuing telemetry transport (“MQTT”), advanced messaging queuing protocol (“AMQP”), internet engineering task force (“IETF”) constrained application protocol (“CoAP”), and extensible messaging and presence protocol (“XMPP”).

The survey generator program 101 may further be in communication with a user 203 via a mobile device 103. Here, the survey generator program 101 may transmit one or more survey questions 107 to the user 203 via the mobile device 103. Similarly, the survey generator program 101 may receive, from the user 203, one or more responses 108 to the one or more survey questions 107 via the mobile device 103.

The survey generator program 101 may further be in communication with the user's 203 profile information via a profile database 204. The profile database 204 may store profile information about the user. Profile information may include, but is not limited to the user's name, phone number, email address, social security number (“SSN”), financial account information (such as credit card numbers, and/or bank accounts), physical address, and historical information (e.g., past purchases and returns, past movement characteristic data, past contextual data, and past responses to survey questions. The survey generator program 101 may further be in communication with environment information via an environment database 205. Environment information may include, but is not limited to: time of day, calendar day, calendar month, and calendar year, ongoing sales or promotions, employee schedules, and weather conditions.

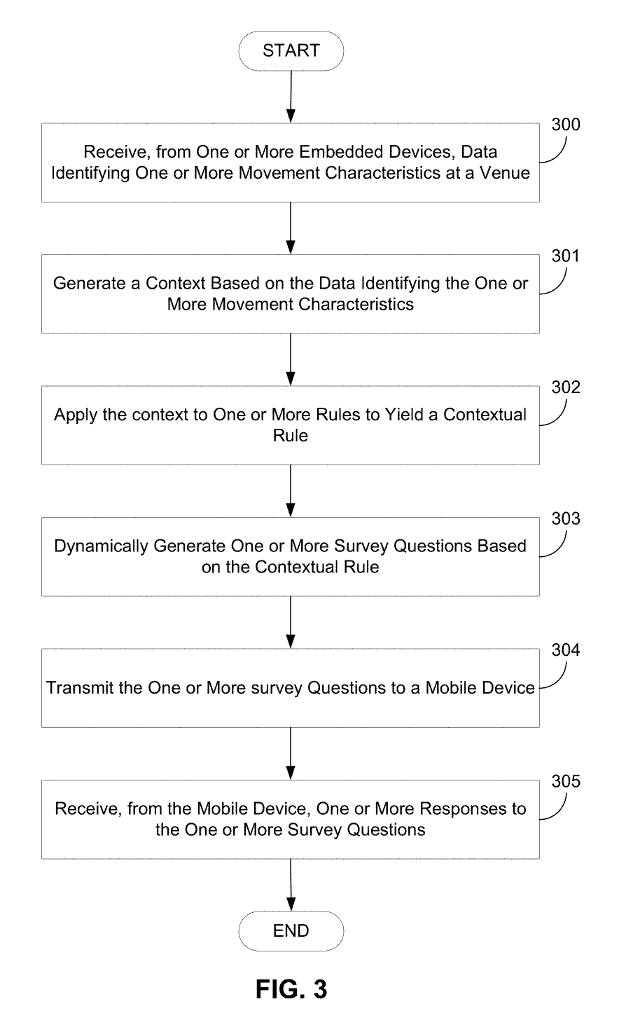

FIG. 3 is a flow chart diagram depicting various steps for the survey generator program in accordance with at least one embodiment of the invention. According to the depicted embodiment, at step 300, the survey generator program 101 may receive data 102 identifying one or more movement characteristics of a mobile device 103 at a venue. Generally, the one or more movement characteristics may identify a path travelled by the mobile device 103 at the venue. More specifically, the one or more movement characteristics may be understood as characteristics of any movement or lack thereof by a mobile device 103 (e.g., smartphone, smart watch, and tablet, etc.) within a venue that may prompt a device (e.g., a mobile device 103 or a network 202 of embedded devices 104) to transmit data 102 to the survey generator program 101. Types of movement characteristics at a venue may include, but are not limited to entering a zone, exiting a zone, and item transactions (e.g., purchasing an item, returning an item, and scanning an item, etc.).

At step 301, the survey generator program 101 may create a context 105 from the data 102. Types of context 105 may include, but are not limited to: (i) mobile device 103 was located in a zone for at least a threshold period of time; (ii) mobile device 103 spent the longest duration of time in a zone; (iii) mobile device 103 spent the shortest duration of time in a zone; and (iv) mobile device 103 entered a zone on more than one occasion. A context 105 may be generated by the survey generator program 101 by any generally known methods. For example, the context “mobile device 103 entered a zone on more than one occasion” may be determined if an embedded device 104 detects the movement characteristic “mobile device 103 has entered Zone X” on more than one occasion. In another example, the context 105 “mobile device 103 spent the longest duration of time in a zone” and the context 105 “mobile device 103 spent the shortest duration of time in a zone” may be determined from the time an embedded device 102 detects the movement characteristic “mobile device 103 has entered zone Y” to the time an embedded device 102 detects the movement characteristic “mobile device 103 has exited zone Y.” In other words, the survey generator program 101 may determine the dwell time of the mobile device 103 in a zone.

At step 302, the survey generator program 101 may dynamically generate one or more survey questions 107. Generating the one or more survey questions 107 may further include applying the context 105 to one or more context based rules 106. For example, a context based rule 106 may include a rule to dynamically generate a survey question 107 regarding an experience in a zone, if the context 105 indicates the mobile device 103 was located in a zone for at least a threshold period of time. In another example, a context based rule 106 may include a rule to dynamically generate a survey question 107 regarding a zone, if the context 105 indicates the mobile device 103 spent the longest duration of time in the zone. In yet another example, a context based rule 106 may include a rule to dynamically generate a survey question 107 regarding a discount on an item in a zone, if the context 105 indicates the mobile device 103 entered the zone on more than one occasion. In another example, a context based rule 106 may include a rule to dynamically generate a survey question 107 regarding purchasing an item in a zone, if the context 105 indicates the mobile device 103 entered the zone at the venue.

The one or more survey questions 107 dynamically generated by the survey generator program 101 may exist for a specific individual at that given moment in time. Thus, one or more survey questions 107 that are dynamically generated by the survey generator program 101 for the same individual at a slightly different moment in time or for an entirely different individual will be different from any prior generated survey questions 107. Here, the survey generator program 101 may incorporate profile and environmental information stored in the profile database 204 and environment database 205 into the one or more survey questions 107. The survey generator program 101 may periodically update the profile database 204 and environment database 205 as information is transmitted to the survey generator program 101 from the one or more devices. Depending on the context 105, the survey generator program 101 may select information stored in the profile database 204 and environment database 205 to dynamically generate customized venue specific survey questions 107.

At step 303, the survey generator program 101 may transmit the one or more survey questions 107 to the mobile device 103. The survey generator program 101 may transmit the one or more survey questions 107 via any generally known transmission methods, including, but not limited to email, push-up notification or SMS message. The survey generator program 101 may transmit the one or more survey questions 107 in real-time.

At step 304, the survey generator program 101 may receive, from the mobile device 103, one or more responses 108 to the one or more survey questions 107. Responses 108 to the one or more survey questions 107 may be entered on a mobile device 103 using a key on a key pad, clicking the screen using a mouse, pressing a button, or touching one or more responses on a touchscreen. More specifically, the one or more responses 108 may be in the form of rating an experience or item, selecting one of several options, as well as entering text.

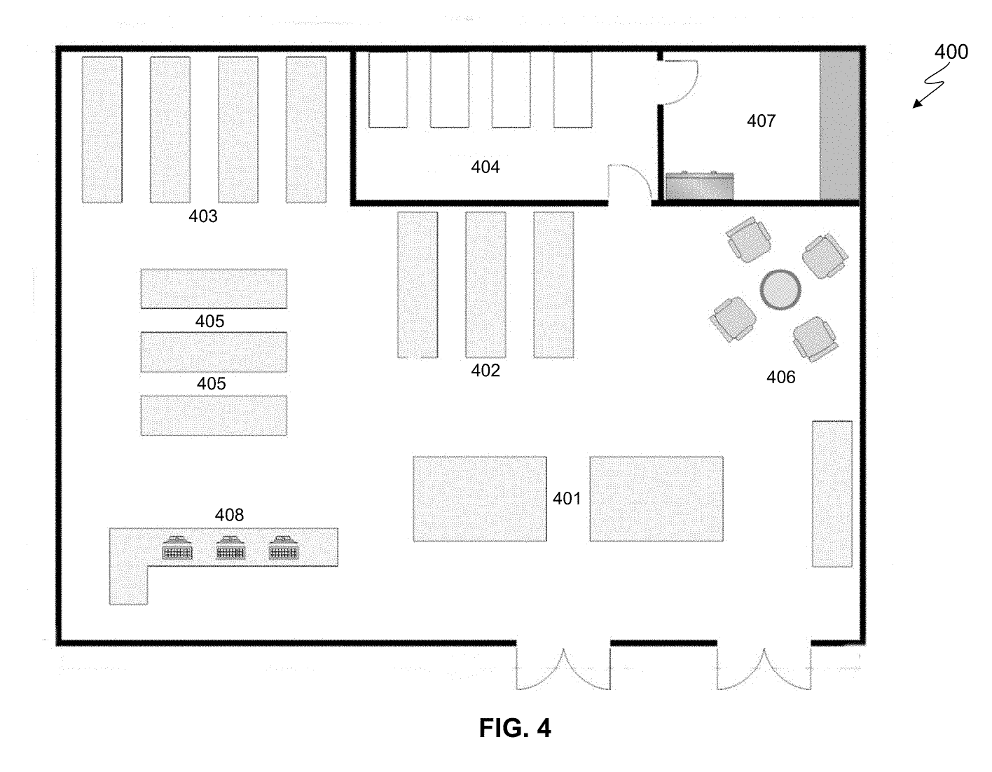

FIG. 4 is an exemplary diagram for a portion of a working example of the survey generator program 101 in accordance with at least one embodiment of the invention. In FIG. 4, the user 203 possessing the mobile device 103 may enter a clothing store 400. The clothing store 400 may include a number of zones. For example, a zone 1 401 may be designated as “Entrance,” a zone 3 403 may be designated as “Jewelry Department,” a zone 5 405 may be designated as “Shoe Department,” and a zone 7 407 may be designated as “Checkout Line.” Each zone may include the network 202 of embedded devices 104. More specifically, the embedded devices 104 may be sensors equipped with micro-enabling location technologies that may detect the one or more movement characteristics of the mobile device 103 at the clothing store 400. As the user 203 possessing the mobile device 103 moves throughout the clothing store 400, the survey generator program 101 may receive, from the one or more embedded devices 104, data 102 identifying the one or more movement characteristics of the mobile device 103 in the clothing store 400.

In one embodiment of the invention, in response to the user 203 entering zone 1 401 (i.e. “Entrance”) of the clothing store 400, an embedded device 104 (e.g., sensor) may detect the presence of the mobile device 103. Detection of the mobile device 103 by the sensor may cause the survey generator program 101 to prompt the user (e.g., “John”) to login to a software application by providing a username and/or password via the mobile device 103. The username may further be linked to the profile database 204 that contains profile information about the user 203. The survey generator program 101 may store data 102 identifying the one or more movement characteristics 104 of the mobile device 103 in “John's” profile database 204.

The survey generator program 101 may further receive transmitted data 102 from a sensor identifying the movement characteristics “mobile device 103 entered a zone” and “mobile device 103 exited a zone.” For example, a sensor located in zone 3 403 may detect the presence of BLE beacons emitted from “John's” mobile device 103. The sensor in zone 3 403 may be programed (i.e. signal strength) such that the sensor may only be able to detect the presence of BLE beacons if the mobile device 103 is located within zone 3 403. The sensor may continue to transmit time stamped data 102 to the survey generator program 101 while “John's” mobile device 103 remains in zone 3 403. When the sensor no longer detects the presence of BLE beacons emitted from “John's” mobile device 103, the sensor will stop transmitting time stamped data 102 to the survey generator program 101. Here, the end of time stamped data 102 being transmitted from the sensor to the survey generator program 101 indicates that “Johns” mobile device 103 has exited zone 3. The survey generator program 101 may continue to receive transmitted data 102 identifying the movement characteristics “mobile device 103 entered a zone” and “mobile device 103 exited a zone” from a different sensor located in each zone of the clothing store 400.

The survey generator program 101 may further receive transmitted data 102 from a sensor identifying the movement characteristic “item transaction.” For example, a user 203 may scan an RFID tag with his mobile device 103 to obtain more information about an item located in zone 5 405. Upon scanning the RFID tag, the mobile device 103 may transmit the information (i.e. data 102) about the item located in zone 5 405 to the survey generator program 101. The survey generator program 101 may store the information about the item located in zone 5 405 in “John's” profile database 204.

The survey generator program 101 may further create a context 105 from the data 102. For example, the survey generator program 101 may create the context 105 ““John's” mobile device 103 visited zone 5 405 on three occasions” if the sensor in zone 5 405 detected the presence of BLE beacons being emitted from “John's” mobile device 103 on three separate occasions. In another example, the survey generator program 101 may create the context 105 ““John's” mobile device 103 was located in zone 7 407 for at least a threshold period of time (e.g., 15 minutes)” if the sensor in zone 7 407 detected the presence of BLE beacons being emitted from “John's” mobile device 103 for 17 minutes. In other words, the survey generator program 101 may determine the dwell time of the mobile device 103 in zone 7 407. In yet another example, the survey generator program 101 may create the context ““John's” mobile device 103 spent the longest time in zone 3 403 (e.g., 20 minutes)” if the sensor in zone 3 403 detected the presence of BLE beacons being emitted from “John's” mobile device 103 for a longer period of time compared to the period of time the mobile device 103 spent in each of the other zones at the clothing store 400.

The survey generator program 101 may further dynamically generate one or more survey questions 107. Generating one or more survey questions 107 may include applying the context 105 to one or more context based rules 106. For example, the context based rule 106 may include a rule to dynamically generate a survey question 107 regarding an experience in a zone (e.g., “Checkout Line” 407), if the context 105 indicates “John's” mobile device 103 was located in the “Checkout Line” (e.g., 17 minutes) for at least a threshold period of time (e.g., 15 minutes).” Here, the survey generator program 101 may dynamically generate a survey question about John's experience in the “Checkout Line” 407: “You had to wait a long time in the checkout line today, do you feel there were enough cashiers working?” The survey generator program 101 may further incorporate environment information (e.g., time of day and calendar day) previously stored by the survey generator program 101 in the environment database 205 when dynamically generating the survey question 107 based on the context 105 applied to the context based rule 106. For example, the survey generator program 101 may generate the survey question for the “Checkout Line” 407: “Was the checkout line crowded when you visited the store Friday morning?”

In another example, the context based rule 106 may include a rule to dynamically generate a survey question 107 regarding an interest in an item in a zone (e.g., “Shoe Department” 405), if the context 105 indicates “John's” mobile device 103 entered the “Shoe Department” 405 on more than one occasion” (e.g., three separate occasions). Here, the survey generator program 101 may dynamically generate a survey question 107 regarding an interest in an item in the “Shoe Department” 405: “You visited the Shoe Department on three different occasions today, what types of shoes are you interested in purchasing?”

In yet another example, the context based rule 106 may include a rule to dynamically generate a survey question 107 regarding a discount on an item in a zone (“Jewelry Department” 403), if the context 105 indicates ““John's” mobile device 103 entered the “Jewelry Department” 403 at the clothing store 400.” Here, the survey generator program 101 may dynamically generate a survey question 107 regarding a discount on an item in the “Jewelry Department” 403: You spent some time today in the Jewelry Department, would you like to receive a 10% discount on our silver earrings?”

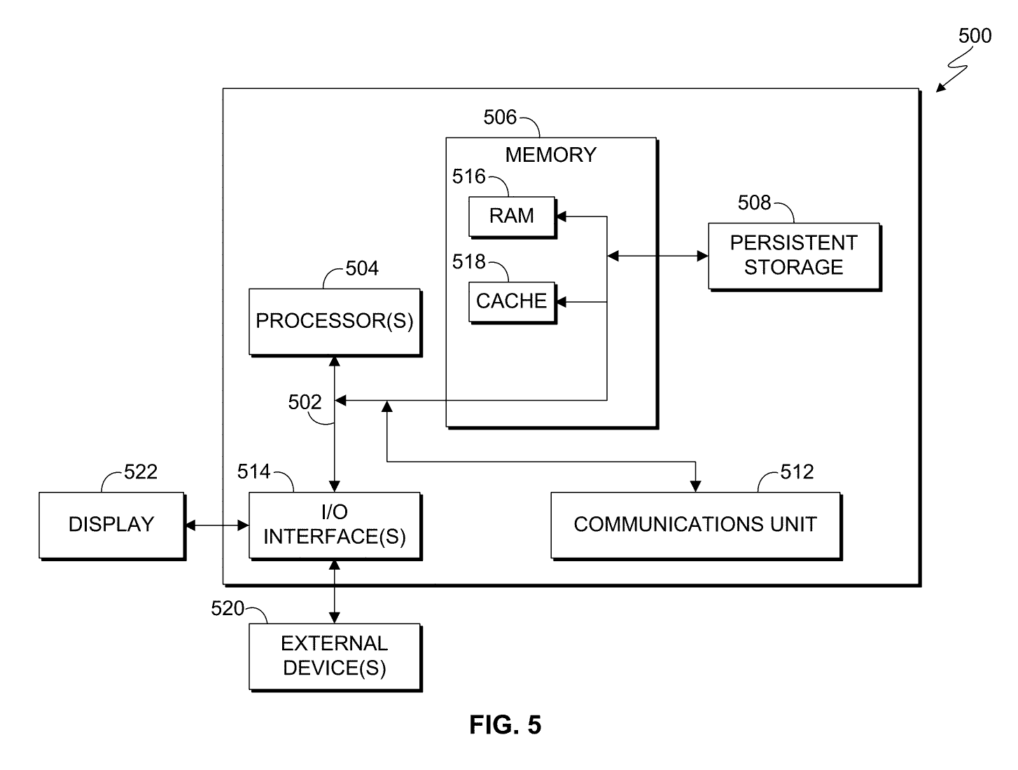

FIG. 5 is a block diagram depicting components of a computer 500 suitable for executing the survey generator program 101, in accordance with at least one embodiment of the invention. FIG. 5 displays the computer 500, one or more processor(s) 504 (including one or more computer processors), a communications fabric 502, a memory 506 including, a RAM 516, and a cache 518, a persistent storage 508, a communications unit 512, I/O interfaces 514, a display 522, and external devices 520. It should be appreciated that FIG. 5 provides only an illustration of one embodiment and does not imply any limitations with regard to the environments in which different embodiments may be implemented. Many modifications to the depicted environment may be made.

As depicted, the computer 500 operates over the communications fabric 502, which provides communications between the computer processor(s) 504, memory 506, persistent storage 508, communications unit 512, and input/output (I/O) interface(s) 514. The communications fabric 502 may be implemented with any architecture suitable for passing data or control information between the processors 504 (e.g., microprocessors, communications processors, and network processors), the memory 506, the external devices 520, and any other hardware components within a system. For example, the communications fabric 502 may be implemented with one or more buses.

The memory 506 and persistent storage 508 are computer readable storage media. In the depicted embodiment, the memory 506 comprises a random access memory (RAM) 516 and a cache 518. In general, the memory 506 may comprise any suitable volatile or non-volatile one or more computer readable storage media.

Program instructions for the survey generator program 101 may be stored in the persistent storage 508, or more generally, any computer readable storage media, for execution by one or more of the respective computer processors 504 via one or more memories of the memory 506. The persistent storage 508 may be a magnetic hard disk drive, a solid state disk drive, a semiconductor storage device, read-only memory (ROM), electronically erasable programmable read-only memory (EEPROM), flash memory, or any other computer readable storage media that is capable of storing program instructions or digital information.

The media used by the persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 may comprise one or more network interface cards. The communications unit 512 may provide communications through the use of either or both physical and wireless communications links. In the context of some embodiments of the present invention, the source of the various input data may be physically remote to the computer 500 such that the input data may be received and the output similarly transmitted via the communications unit 512.

The I/O interface(s) 514 allow for input and output of data with other devices that may operate in conjunction with the computer 500. For example, the I/O interface 514 may provide a connection to the external devices 520, which may be as a keyboard, keypad, a touch screen, or other suitable input devices. External devices 520 may also include portable computer readable storage media, for example thumb drives, portable optical or magnetic disks, and memory cards. Software and data used to practice embodiments of the present invention may be stored on such portable computer readable storage media and may be loaded onto the persistent storage 508 via the I/O interface(s) 514. The I/O interface(s) 514 may similarly connect to a display 522. The display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, from a network of embedded devices, data identifying one or more movement characteristics of a mobile device at a venue, wherein:
said network of embedded devices are nodes in a wireless sensor network; and
said one or more movement characteristics identify a path travelled by said mobile device at said venue;
creating a context from said data;
dynamically generating one or more survey questions, said generating based, at least in part, on:
incorporating profile information associated with a user of said mobile device and environment information into the one or more survey questions; and
applying said context to one or more context based rules, wherein said one or more context based rules include:
a first rule to dynamically generate a survey question regarding an experience in a zone, if said context indicates said mobile device was located in said zone for at least a threshold period of time;
a second rule to dynamically generate a survey question regarding a zone, if said context indicates said mobile device spent the longest duration of time in said zone;
a third rule to dynamically generate a survey question regarding an interest in an item in a zone, if said context indicates said mobile device entered said zone on more than one occasion; and
a fourth rule to dynamically generate a survey question regarding a discount on an item in a zone, if said context indicates said mobile device entered said zone at said venue;
transmitting said one or more survey questions to a mobile device; and
receiving, from said mobile device, one or more responses to said one or more survey questions.
